(19) United States
(12) Patent Application Publication
(10) Pub. No.: US 2008/0310612 A1
(43) Pub. Date: Dec. 18, 2008

(54) System, method and device supporting delivery of device-specific data objects

(75) Inventors: Leland Scott Bloebaum, Cary, NC (US); William O. Camp, JR., Chapel Hill, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/128,953

(22) Filed: May 29, 2008

Related U.S. Application Data
(60) Provisional application No. 60/944,385, filed on Jun. 15, 2007.

(51) Int. Cl. H04M 3/42

(52) U.S. Cl. 379/215.01

(57) ABSTRACT

A technique for supporting delivery of a data object used to alert a called party to a call from a calling party is described. The technique comprises receiving a call setup request from a calling communication device associated with the calling party. Next, a call setup is initiated with one or more called communication devices associated with the called party. In response to the call setup, a request for the data object for each of the one or more called communication devices is received. Finally, the data object is transferred to each of one or more called communication devices, wherein the data object is used by the one or more called communication devices to alert the called party to the call from the calling party.

### RELATED APPLICATIONS

The present application claims priority under 35 U.S.C. Section 119(e) to U.S. Provisional Patent Application 60/944,385, filed 15 Jun. 2007, the entire contents of which are incorporated by reference herein.

### TECHNICAL FIELD

The present invention relates generally to a method and apparatus for exchanging information in a communication system. More specifically, the invention relates to methods and apparatus for transferring data objects in connection with the establishment of a communication session between two or more communication terminals.

### BACKGROUND

With the convergence of voice and data communication networks, portable communication devices are increasingly likely to support several communication modes, as well as a number of communication-related applications. Single-purpose cellular phones and alphanumeric pagers have given way to complex mobile devices supporting voice communications, e-mail, and instant messaging. A typical device often includes a camera, a music player, and sound recorder, and may include a global positioning system (GPS) receiver. Many of these devices and their supporting wireless networks now enable simultaneous use of multiple communication modes. Thus, a device user today might engage in a voice call and simultaneously send or receive text messages, digital images, video clips, or the like.

A few applications have been developed to take advantage of this simultaneous availability of multiple communication modes. In particular, several patents and patent application publications describe a so-called Phone Pages system, in which the generation and transfer of multimedia data objects is triggered by various communication-related events. These data objects, or Phone Pages, thus supplement a primary communication session, such as a voice call, an e-mail exchange, or an instant message conversation. The Phone Pages concept is described in the following patents and patent application publications, the contents of which are each incorporated by reference herein: U.S. Pat. No. 6,922,721, titled “Exchange of Information in a Communication System” and issued on Jul. 26, 2005 to Minborg et al.; U.S. Patent Application Publication 2005/0271041 A1, titled “Exchange of Information in a Communication System” and filed on Jun. 1, 2005 by Minborg et al.; U.S. Pat. No. 6,996,072, titled “Method and Apparatus for Exchange of Information in a Communication Network” and issued on Feb. 7, 2006 to Minborg; U.S. Pat. No. 6,977,909, titled “System and Method for Exchange of Information in a Communication Network” and issued on Dec. 20, 2005 to Minborg; and U.S. Patent Application Publication 2006/0114845, also titled “System and Method for Exchange of Information in a Communication network” and filed on Nov. 14, 2005 by Minborg.

The communication techniques and systems described in the preceding references provide a variety of enhancements to conventional modes of communication, facilitating the convenient exchange of various data objects between users of communication devices. These enhancements may be quite valuable both for promoting personal relationships and for supporting business and enterprise communications. However, further enhancements to ensure that appropriate data objects are transferred at appropriate times are needed.

### SUMMARY

As noted above, improved techniques for regulating the automatic transfer of data objects in communication systems are needed. In particular, current systems and methods do not provide adequate support for delivery of data objects used to alert a called party to a call from a calling party.

According to some embodiments of the present invention, systems and methods for supporting delivery of a data object used to alert a called party to a call from a calling party are provided. An exemplary method comprises the steps of receiving a call setup request from a calling communication device associated with the calling party and initiating a call setup with one or more called communication devices associated with the called party. In various embodiments of the invention, initiating the call setup with the one or more called communication devices includes sending an instruction to the one or more called communication devices that instructs the devices to either wait for one or more caller-originated alert signals or to download one or more caller-originated alert signals.

In some embodiments, the method further comprises receiving a request for the data object from one or more of the called communication devices, in response to the call setup, and transferring the data object to each of one or more called communication devices, wherein the data object is used by the devices to alert the called party to the call from the calling party. In other embodiments, the method instead comprises sending a request to a data object server for transfer of the data object to each of one or more of the called communication devices. In these embodiments, the data object may again be used by the devices to alert a user of an incoming call.

In yet other embodiments of the various systems and methods described herein, various communication servers for supporting delivery of a data object used to alert a called party to a call from a calling party are provided. These servers may be configured to carry out one or more of the methods described herein. In particular, an exemplary server comprises processing logic configured to receive a call setup request from a calling communication device and to initiate a call setup with one or more called communication devices associated with the called party. The initiation of the call setup includes sending to the one or more called communication devices one of an instruction to wait for one or more caller-originated alert signals and an instruction to download one or more caller-originated alert signals.

Some embodiments of the communication server include processing logic further configured to receive a request for the data object from one or more of the called communication devices, in response to the call setup, and to transfer the data object to each of one or more called communication devices, wherein the data object is used by the one or more called communication devices to alert the called party to the call from the calling party. In other embodiments, the processing logic is instead configured to send a request to a data object server for transfer of the data object to each of one or more of the called communication devices.

Of course, those skilled in the art will appreciate that the present invention is not limited to the above contexts or examples, and will recognize additional features and advantages upon reading the following detailed description and upon viewing the accompanying drawings.

### BRIEF DESCRIPTION OF THE DRAWINGS

The invention will now be more thoroughly described and features and advantages will become readily apparent by reading the following detailed description, where references will be made to the accompanying figures, where:

FIG. 1 illustrates an overview of a communication infrastructure overview according to one embodiment of the invention;

FIG. 2 provides a simplified view of a system for supporting delivery of data objects according to some embodiments of the invention;

FIG. 3 is a logic flow diagram illustrating an exemplary method for supporting delivery of data objects;

FIG. 4 is a block diagram illustrating an exemplary communication device; and

FIG. 5 is a block diagram illustrating an exemplary data object server.

### DETAILED DESCRIPTION

The present invention is described below in reference to a wireless telecommunications system providing voice and data services to a mobile device. Various systems providing voice and data services have been deployed, such as GSM networks (providing circuit-switched communications) and GPRS (providing packet-switched communications); still others are currently under development. These systems may employ any or several of a number of wireless access technologies, such as Time Division Multiple Access (TDMA), Code Division Multiple Access (CDMA), Frequency Division Multiple Access (FDMA), Orthogonal Frequency Division Multiple Access (OFDMA), Time Division Duplex (TDD), and Frequency Division Duplex (FDD). The present invention is not limited to any specific type of wireless communication network or access technology. Indeed, those skilled in the art will appreciate that the network configurations discussed herein are only illustrative. The inventive techniques disclosed herein may be applied to “wired” devices accessing conventional voice or data networks, as well as wireless devices. The invention may be practiced with devices accessing voice and/or data networks via wireless local area networks (WLANs) or via one or more of the emerging wide-area wireless data networks, such as those under development by the 3rd-Generation Partnership Project (3GPP).

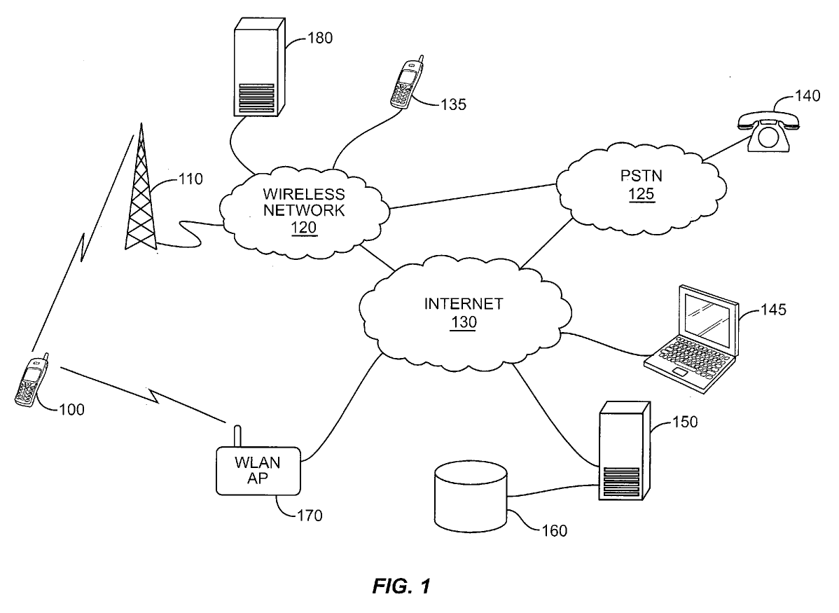

FIG. 1 illustrates an exemplary communication system in which the present invention may be employed. Communication device 100 communicates with other devices through base station 110, which is connected to wireless network 120. Wireless network 120 is in turn connected to the Public Switched Telephone Network (PSTN) 125 and the Internet 130. Wireless device 100 can thus communicate with various other devices, such as wireless device 135, conventional land-line telephone 140, or personal computer 145. In FIG. 1, wireless device 100 also has access to data server 150 via the Internet 130; data server 150 may be configured to provide access through Internet 130 to data or applications stored in storage device 160. Storage device 160 may comprise one or more of a variety of data storage devices, such as disk drives connected to data server 150 or one or more other servers, a Redundant Array of Independent Drives (RAID) system, or the like.

Communication device 100 may be a cordless telephone, cellular telephone, personal digital assistant (PDA), communicator, computer device, or the like, and may be compatible with any of a variety of communications standards, such as the Global System for Mobile Communications (GSM) or one or more of the standards promulgated by 3GPP. Communication device 100 may include a digital camera, for still and video images, as well as a digital sound recorder and digital music player application. Communication device 100 may also support various applications in addition to voice communications, such as e-mail, text messaging, picture messaging, instant messaging, video conferencing, web browsing, and the like.

Communication device 100 also includes a wireless local-area network (WLAN) transceiver configured for communication with WLAN access point 170. WLAN access point 170 is also connected to Internet 130, providing communication device 100 with alternative connectivity to Internet-based resources such as data server 150.

Also connected to wireless network 120 is location server 180. Location server 180 is typically maintained by the operator of wireless network 120, but may be separately administered. The main function of location server 180 is to determine the geographic location of mobile terminals (such as mobile terminal 100) using the wireless network 120. Location information obtained by location server 180 may range from information identifying the cell currently serving mobile terminal 100 to more precise location information obtained using Global Positioning System (GPS) technology.

Other technologies, including triangulation methods exploiting signals transmitted from or received at several base stations, may also be used to obtain location information. Triangulation techniques may include Time Difference of Arrival (TDOA) technology, which utilizes measurements of a mobile's uplink signal at several base stations, or Enhanced-Observed Time Difference (E-OTD) technology, which utilizes measurements taken at the mobile terminal 100 of signals sent from several base stations. GPS-based technologies may include Assisted-GPS, which utilizes information about the current status of the GPS satellites derived independently of the mobile terminal 100 to aid in the determination of the terminal's location.

In some embodiments, the various systems and methods described herein facilitate the selective delivery of data objects to a communication device, such as mobile terminal 135, in communication with another device, such as mobile terminal 100. The data object may be transferred from one device to the other, e.g., from mobile terminal 100 to mobile terminal 135, or from a data object server, such as server 150 or server 180, in response to a request from either of the communication devices.

Typically, the users of the communication devices are engaged in a communication session, which may comprise a voice call (whether circuit-switched or packet-switched), an instant message (IM) session, or any other modes of communication such as those described herein or combinations thereof. In some embodiments, one or both of the communication devices may include a module or application that is able to determine the occurrence of a communications-related trigger event in the communication device and to thereafter transmit and/or receive data, such as data specifically related to the trigger event. The trigger event may comprise, for example, any of the following events or combinations thereof:
the establishment of a session or call between the devices;
the arrival or departure of a device in a multi-party communication session;
activation by the user of one or both of the communication devices (e.g., an explicit request by one user for transfer of a data object to the other);
timer-based periodic or random trigger event in communication device;
crossing a geographic boundary, such as a boundary established by the user of one of the communication devices; or
other events related to the communication, such as those described in U.S. Pat. No. 6,996,072.

Other trigger events might include, but are not limited to:
An outgoing call is or is about to be initiated.
A called party answers a call.
A called party is busy.
A called party does not answer after a pre-determined time or number of rings.
A called party rejects a call.
A called party is unavailable (e.g., an addressed mobile phone is out of coverage).
An incoming call is imminent or has just started.
A conference call is or is about to be initiated.
A call is disconnected.
A call is conducted (under which several triggering events can be generated).
A party is placed on hold.
The location of a party has changed.
A communication device is switched on or off.
A special-function button is pressed on a communication device.
A button or other user interface device is activated in response to a query.
A voice mail, text message, e-mail, instant message, or the like is received.
A voice mail, text message, e-mail, instant message, or the like is received.

While many of the preceding trigger events are related to traditional voice communications, those skilled in the art will appreciate that many analogous trigger events will apply to other communication modes, such as instant messaging, e-mail, video conferencing, “chat” sessions, and so on.

According to some embodiments of the present invention, the various systems, devices and methods described herein provide the ability to support delivery of device-specific data objects. While delivery of device-specific data objects will be described below in the context of one or more types of communications, the embodiments described below are applicable for use with any other mode of communication such as those described herein, including circuit-switched voice or data calls, Voice-Over-Internet-Protocol (VoIP) communications, instant messaging, or video conferencing. Further, while device-specific data objects will be described below in the context of device-specific alert signals, the embodiments described below are applicable for use with any other data object.

In some embodiments, the delivery of one or more device-specific data objects is initiated when a first user, User A, is attempting to establish a communication session (e.g., a voice call session or an instant messaging session) with a second user, User B. In this scenario, the data object may be an alert signal. The communication attempt is made utilizing a communication device or user equipment (UE) associated with User A (UE A) and the communication attempt is made to one or more UE associated with User B (UE B). UE A may cause one or more device-specific alert signals to be sent to one or more UE B, prior to the establishment of the communication session, to alert User B of the upcoming communication session. Specifically, upon selection of one or more UE B for communication, the UE A may transmit a call setup request to a communication server and also indicate to the communication server the intent to send one or more device-specific alert signals.

The one or more device-specific alert signals may comprise an alert signal that has been previously generated by User A or another source. Further, the one or more device-specific alert signals may be referred to generally as “a caller-originated alert” or “a caller-originated alert signal,” wherein the word “caller” refers to a party who initiates a communication session. As used herein, the use of the term “call” or “caller” is not intended to limit the scope of the presently described methods and systems to voice calls. In some embodiments, the caller-originated alert is specific to the UE intended to receive the alert.

In some embodiments, the communication server may initiate the call setup with the one or more UE B and provide instruction to wait for the one or more caller-originated alert signals. The communication server may also contact a data object server to cause it to deliver the caller-originated alert signal to the one or more UE B. However, in other embodiments, the communication server may forward the call setup request to the one or more UE B and provide instruction for the one or more UE B to download the device-specific alert signal from a data object server. Once the one or more UE B possess the alert signal, the one or more UE B may then render the one or more alert signals to alert User B of the communication session.

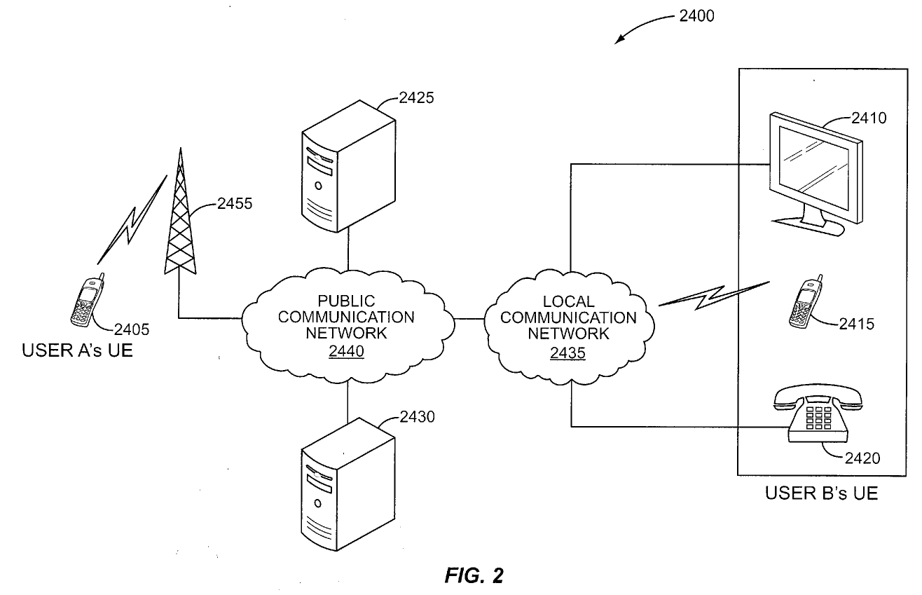

Referring to FIG. 2, there is illustrated a block diagram of an exemplary system 2400 depicting a UE A 2405 associated with User A; several communication devices associated with User B, including UE B1 2410, UE B2 2415, and UE B3 2420; a communication server 2425; a data object server 2430; a local communication network 2435; a public communication network 2440; and a public wireless communication network 2455.

Any of UE A 2405, UE B1 2410, UE B2 2415 and UE B3 2420 may comprise any of the various communication terminals described in this application, such as, for example, UE 100 of FIG. 1. Further, any of UE A 2405, UE B1 2410, UE B2 2415 and UE B3 2420 may be a mobile telephone or a mobile telephone connected to any kind of data equipment, e.g., personal digital assistant (PDA) devices or laptop computer. Any of UE A 2405, UE B1 2410, UE B2 2415 and UE B3 2420 may also be a fixed non-mobile device such as a desktop computer, a gaming device, an IP telephone, or other devices which can initiate and receive communications. Any of UE A 2405, UE B1 2410, UE B2 2415 and UE B3 2420 may be capable of communicating with other UE in a variety of ways. For example, UE A 2405 may establish a voice call, such as a Voice-over-IP (VOIP) call, with any of UE B1 2410, UE B2 2415 and UE B3 2420. UE A 2405 may also establish a wireless “walkie-talkie” session based on push-to-talk (PTT) technology. UE A 2405 may alternatively establish a data or multimedia communication session (e.g., email, instant messaging, online meeting, document sharing, and file transfers) with any of UE B1 2410, UE B2 2415 and UE B3 2420. Any of UE B1 2410, UE B2 2415 and UE B3 2420 may have comparable or at least compatible functionalities in order to communicate with UE A 2405.

UE A 2405, UE B1 2410, UE B2 2415 and UE B3 2420 may be configured to communicate with the data object server 2430. The data object server 2430 may comprise any of the data object servers described herein, such as data server 150 of FIG. 1, or any of the other server devices described herein. As will be readily understood by those skilled in the art, the data object server 2430 may communicate with UE A 2405, UE B1 2410, UE B2 2415 and UE B3 2420 via one or more logical channels, typically to receive requests (directly or indirectly) from UE A 2405 and to fulfill those requests according to one or more established messaging or signalling protocol, including any of the numerous standards and protocols currently employed for Internet-based communications, VoIP communications, instant messaging, and the like. Further, the communication between UE A and UE B, via the communication networks 2435 and 2440, may be carried on another logical channel, e.g., a separate channel from the one or more logical channels used for signalling or messaging between the communication server 2425 and UE A and/or UE B. Further, the communication session between UE A and UE B is not limited to a one-to-one type of communication, but may be part of a multiple-party communication (e.g., a conference call or an online meeting). That is, either or both of UE A and UE B may simultaneously communicate with other parties.

UE B1 2410, UE B2 2415 and UE B3 2420 communicate via local communication network 2435 using wired or wireless connections, as is known in the art. Communication server 2425, data object server 2430 and local communication network 2435 communicate via a public communication network 2440. An exemplary public communication network includes the Internet. UE A 2405 is illustrated as communicating with public communication network 2440 via wireless communication network 2455. However, UE A 2405 may alternatively communicate with public communication network 2440 directly.

The communication server 2425 may be any type of communication equipment that hosts or facilitates communication sessions among two or more UE. For example, the communication server 2425 may be a proxy server or a similar network element. The communication session between UE A 2405 and any of UE B1 2410, UE B2 2415 and UE B3 2420 may be carried on a packet-switched network. For example, the communication session may be a VoIP call or an instant messaging (IM) session that traverses an IP-based network (e.g., the Internet). Or, the communication session may be a voice call or data session that is partially carried on an IP-based network and partially carried on a telephone (land-line and/or wireless) network.

The arrangement of elements depicted in FIG. 2 is merely exemplary. For example, the three devices shown as User B's devices, UE B1 2410, UE B2 2415 and UE B3 2420, are intended to represent a plurality of devices that are active or ready to receive communication, not limited by type or number as shown. Accordingly, those of ordinary skill in the art will recognize that various changes and modifications of the system illustrated in FIG. 2 and described herein can be made without departing from the scope and spirit of the invention. Also, descriptions of well-known functions and constructions are omitted for clarity and conciseness.

In some embodiments, the various systems, devices and methods described herein enable UE A 2405 to provide to any number of UE B1 2410, UE B2 2415 and UE B3 2420 a data object that is customized based on the identity of User A and User B or their associated UE, a particular event that occurs during the communication between User A and User B, and/or the particular capabilities of UE A 2405, UE B1 2410, UE B2 2415 and UE B3 2420. Any number of UE B1 2410, UE B2 2415 and UE B3 2420 may be used to alert User B to the incoming call and may be used to participate in the call. Each of UE B1 2410, UE B2 2415 and UE B3 2420 may include various capabilities for rendering audible, visible, or tactile signals.

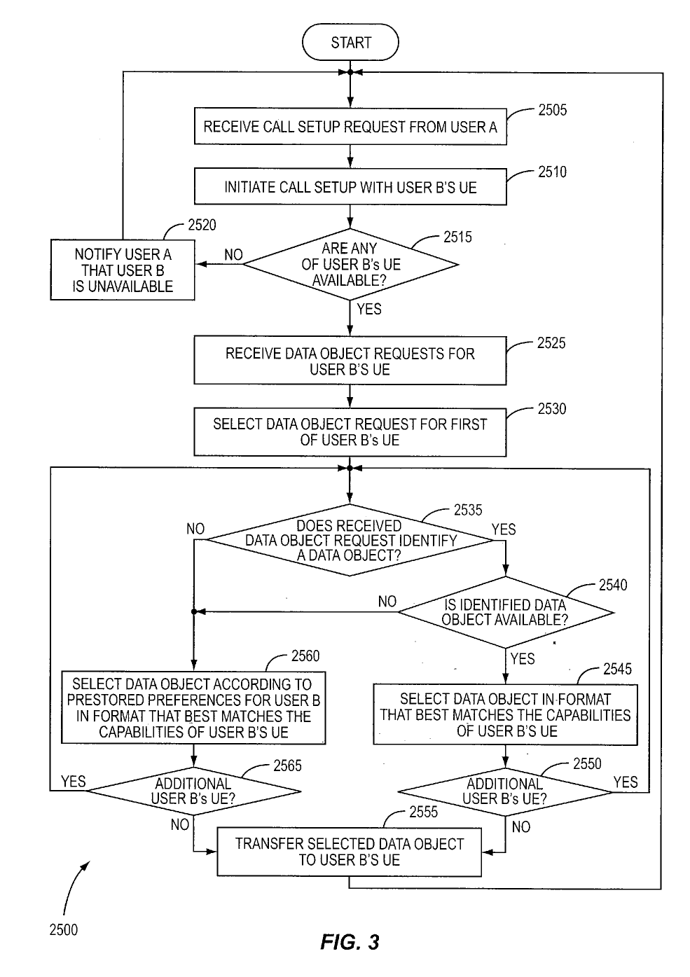

FIG. 3 illustrates an embodiment of a method 2500 for supporting delivery of device-specific data objects, using the system illustrated in FIG. 2. As shown, at step 2505 a communication request is received from UE A 2405 for the purpose of User A initiating a call or session with User B.

According to one embodiment, the communication request is generated by UE A 2405 and includes the identity and/or address of User A and/or UE A 2405. The communication request further includes the identity and/or address of User B and/or UE B1 2410, UE B2 2415 and UE B3 2420. Exemplary identifiers include a telephone number, Internet Protocol (IP) address, or Session Initiation Protocol (SIP) address. However, any other appropriate identification or addressing means may be utilized. In some embodiments, when UE A 2405 is selecting an identifier and/or address for User B, UE B1 2410, UE B2 2415 and/or UE B3 2420, UE A 2405 selects the identifier and/or address from a phone book or “buddy list” stored locally on or remote from UE A 2405. Alternatively, User A may directly enter the identifier and/or address for User B, UE B1 2410, UE B2 2415 and/or UE B3 2420 into UE A 2405.

In some embodiments, the call setup request from UE A 2405 may optionally include several additional elements. A first optional element is an indication of User A's intent to alert User B of the call or session using a data object. A second optional element is an address of a data object server 2430 where the data object is available. A third optional element is an identifier of the type of data object that User A wants to use to alert User B of the call or session.

After receiving the call request from User A in step 2505, communication server 2425, in step 2510, determines to which of User B's UE a call is to be setup. The determination varies depending on the information included in the call setup request from UE A 2405. When UE A 2405 includes the identity and/or address of User B, communication server 2425 determines which UE is associated with User B and their respective addresses. Further, communication server 2425 may determine a subset of the UE associated with User B to be used to alert User B. The subset may be determined from preferences stored in a profile for User B that is either locally or remotely located. Alternatively, communication server 2425 may determine the subset to be the most likely UE to answer the call based on User B's communication history, location or time of the day. Further, communication server 2425 may determine the subset based on a cost associated with the use of the connection. When UE A 2405 identifies particular UE in the call request, communication server 2425 uses the identified UE unless it conflicts with preferences set in User B's profile. Once communication server 2425 determines which of User B's UE is to be used, communication server 2425 initiates a call setup with User B's UE. The call setup with User B's UE will comprise one of an instruction to wait for the one or more caller-originated alert signals and an instruction to download the one or more caller-originated alert signals from data object server 2430. The inclusion of one instruction or the other depends on whether communication server 2425 is to contact a data object server 2430 to cause it to deliver the caller-originated alert signal to the one or more UE B or if the one or more UE B are to download the caller-originated alert signal from the data object server 2430.

In step 2515, communication server 2425 determines the availability of User B's UE that are to be used. If all of User B's UE that are to be used are unavailable (e.g., not registered or unavailable according to a presence management system), communication server 2425 notifies UE A 2405 of User B's unavailability in step 2520.

In step 2525, data object server 2430 receives a data object request from one of communication server 2425 and User B's UE that are to be used. The data object request varies depending on which optional elements have been included in the call setup request from UE A 2405 in step 2505. If the optional element indicating User A's intent to alert User B with the data object is present, each of User B's UE that are to be used contacts data object server 2430. Alternatively, communication server 2425 contacts data object server 2430.

Further, if the optional address element was included in the call setup request from UE A 2405 in step 2505, the optional address element is used to contact data object server 2430. However, if the optional address element was not included in User A's call setup request, a default address is used. The default address can be an address that is stored at communication server 2425 or User B's UE that are to be used. Alternatively, the default address can be determined from information stored at a remote location. In this case, the information stored at a remote location may comprise a profile for User B and/or User B's UE that are to be used. Furthermore, even if both the indication of intent and address elements are absent from User A's call setup request, communication server 2425 or each of the available User B's UE that are to be used may still contact data object server 2430 if a predetermine triggering condition is met. For example, User A and/or UE A 2405 may be identified on a “buddy list” for User B that references or provides a substitute for either or both of the missing elements.

Furthermore, if User B has muted alert functions on any of User B's UE that are to be used, for example, during a meeting or in a theater, any of User B's UE that are to be used may reject the incoming caller-originated alert from the data object server 2430. Alternatively, User B's UE that are to be used may still proceed to receive or retrieve the caller-originated alert signal and then apply settings to determine how the alert signal is to be rendered. The settings may be stored locally with each of User B's UE or remotely. Both options may be accommodated by a protocol between User B's UE and the data object server 2425. The protocol may allow User B's UE that are to be used to reject the caller-originated alert or allow the data object server 2425 to override the rejection from User B's UE in case User B does not have the right to reject a certain alert, either for commercial (e.g., condition of service) or regulatory reasons.

All requests to data object server 2430 from communication server 2425 or User B's UE that are to be used include information on the identity of Users A and B and/or their UE. Also, all requests to data object server 2430 from communication server 2425 or User B's UE that are to be used include information on the specific rendering capabilities of User B's UE. Further, requests to data object server 2430 from communication server 2425 or User B's UE that are to be used may include the identity of the data object or type of data object being requested.

In step 2530, data object server 2430 determines if more than one data object request for User B's UE are to be processed and selects the data object request for the first UE to be processed.

As discussed above, the data object request may optionally include an identifier of the type of data object that User A wants to use to alert User B. Accordingly, in step 2535, data object server 2430 determines if the received data object request identifies a particular data object to be used to alert User B. If the data object request identifies a particular data object, data object server 2430 then determines if the identified data object is available in step 2540. If the specified data object is available, data object server 2430 selects the data object in a format that best matches the capabilities of User B's UE that are to be used in step 2545.

Then in step 2550, data object server 2430 determines if there is another data object request for another of User B's UE that needs to be processed. If there is, the method returns to step 2535. Otherwise the method proceeds to step 2555. In step 2555, data object server 2430 queues the selected data object for transfer to User B's UE. As will be discussed in further detail below, data object server 2430 may send the selected data objects sequentially or simultaneously.

Returning to steps 2535 and 2540, if data object server 2430 determines that the received data object request does not identify a particular data object or that the identified particular data object is unavailable, step 2560 is performed. In step 2560, data object server 2430 selects a data object according to pre-stored preferences for User B and/or User B's UE that are to be used, in a format that best matches the individual capabilities of User B's UE that are to be used. Exemplary pre-stored preferences for User B and/or User B's UE may include an identification of a data object to be used for User B and/or User B's UE, a data object to use for a call from User A and/or UE A 2405, a data object to use for a specific type of communication device, or a data object to use during a specific time or at a specific place. Further, the pre-stored preferences may include a default data object to be used when a data object is not determined from any of the other pre-stored preferences. Then in step 2565, data object server 2430 determines if there is another data object request for another of User B's UE that needs to be processed. If there is, the method returns to step 2535. Otherwise the method proceeds to step 2555.

If more than one of User B's UE are to be used than data object server 2430 will receive multiple requests. When multiple requests are received, data object server 2430 may send all of the responses at once or may order the sending of the corresponding responses in a particular manner, such as in order of the sizes of the respective responses starting with the largest and ending with the smallest or in an order of likely usage. Herein, once one of User B's UE answers the call, communication server 2425 notifies data object server 2430 which in turn terminates the remaining transfers.

In some embodiments, data object server 2425 may transmit the entire data object to UE B before UE B begins rendering it. Alternatively, the data object may be streamed to UE B in a series of data packets which UE B can start rendering without waiting for the entire alert signal to be downloaded. The delivery of the data object may follow any IP-based, multimedia streaming or download protocol such as Stream Control Transmission Protocol (SCTP).

While rendering the received data object(s), each of User B's UE also may display information that was received in the call setup from communication server 2425, such as caller ID information. Subsequently, conventional procedures are used to establish, conduct and terminate the call or session.

In some embodiments, once User B's device(s) 2410-2420 answers the call on a particular device, subsequent data objects are exchanged between Users A's device 2405 and User B's device(s) 2410-2420 based on the capabilities of the devices being used.

In some embodiments, UE A 2405 or User B's device(s) 2410-2420 may send a data object in response to a user or device triggered event that may indicate or offer the possibility to switch the actual call mode. For example, if User B's device(s) 2410-2420 answers the call on a home entertainment system, the home entertainment system may send a data object to UE A 2405 with a request to switch to a video call, such as by clicking on a link in that data object, which would trigger a re-negotiation of the call capabilities between the two devices.

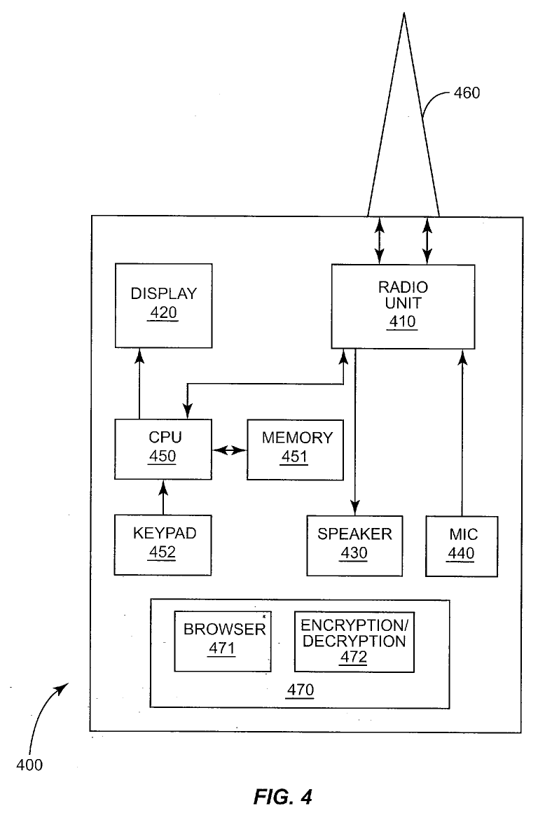

FIG. 4 illustrates an exemplary communication device 400 to be used in one or more embodiments of the present invention. In the pictured embodiment, communication device 400 may comprise a mobile telephone, or a personal digital assistance (PDA) device with mobile telephone capabilities. Communication device 400 includes a central processing unit (CPU) 450, connected to at least one memory unit 451, and at least one display 420. The CPU 450 may also be connected to a keyboard device or area 452 to allow subscribers to enter, for example, digits or alphanumeric characters. The memory unit 451 may include non-volatile memory (e.g., flash, EEPROM or SIM card) in order to retain stored information, should power be temporarily unavailable.

The CPU 450 is further connected to a radio unit 410 configured to convert incoming and outgoing data to and from radio frequency (RF) modulated signals. The radio unit 410 also connects to an antenna 460 for transmission and reception of the RF signals. Radio unit 410 may also directly or indirectly be connected to an earphone 430 and a microphone 440 in order to allow voice communication. Communication device 400 may further comprise a plurality of programs 470, such as a browser 471, that can render at least one type of data object, and an encryption/decryption engine 472, allowing data object requests to be encrypted and data objects to be decrypted. Communication device 400 may optionally be equipped with a cache memory in which it is possible to store and retrieve data objects without occupying transmission resources within the communication network.

In some embodiments of the present invention, CPU 450 and/or other processing logic included in communication device 400 is configured in accordance with one or more of the systems or techniques described above. In particular, communication device 400 may comprise processing logic configured to send a call setup request to a communication server, wherein the call setup request includes one or more of the parameters discussed earlier. In some embodiments, communication device 400 may further comprise processing logic configured to respond to a call setup initiated by a communication server by sending a request for a data object to a data object server. In various embodiments, the request for the data object may be addressed to an address identified in the call setup, or to an address retrieved from a locally stored profile for the called device or the calling device. The request for the data object may comprise an identifier for a specific data object, or an identifier for a type of data object. In some embodiments, the request may comprise information characterizing one or more capabilities of the called device.

The data object, as discussed above, comprises content, e.g., multimedia content, which may be used by the receiving device to alert a user of an incoming call or other communication session.

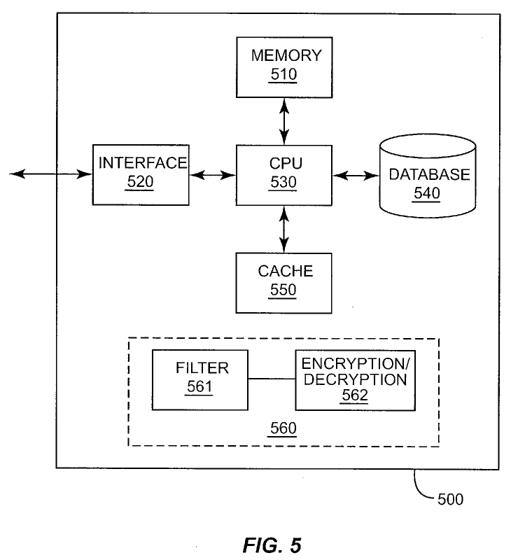

FIG. 5 illustrates an exemplary communication server and/or data object server 500 according to one or more embodiments of the present invention. Server 500 comprises at least one CPU 530 connected to at least one memory device 510, a cache memory 550, at least one database 540 and at least one network interface 520. Memory devices 510 and databases 540 may include non-volatile memory, such as flash, magnetic, or optical storage devices. Network interface 520 enables the CPU 530 to send and receive data to/from the data network 130. The cache memory 550 allows storage of frequently used data objects so that the CPU 530 may obtain them readily. The database 540 contains the actual data objects that can be requested by a communication device, such as communication device 400, via, for example, the wireless network 120 and Internet 130 pictured in FIG. 1. The data object server may further comprise a number of programs 560 including, but not limited to, a filter 561, allowing the data objects to be optimized according to the rendering capabilities of the communication device 400, and an encryption/decryption engine 562, allowing data object requests to be decrypted and data objects to be encrypted.

In some embodiments of the present invention, server 500 is configured to carry out one or more of the methods described above. In particular, server 500 may comprise processing logic (e.g., CPU 530, configured with appropriate software) configured to receive a call setup request from a calling communication device and to initiate a call setup with one or more called communication devices associated with the called party. The initiation of the call setup includes sending to the one or more called communication devices one of an instruction to wait for one or more caller-originated alert signals and an instruction to download one or more caller-originated alert signals.

Some embodiments of the server 500 may include processing logic further configured to receive a request for the data object from one or more of the called communication devices, in response to the call setup, and to transfer the data object to each of one or more called communication devices, wherein the data object is used by the one or more called communication devices to alert the called party to the call from the calling party. In other embodiments, the processing logic is instead configured to send a request to a data object server for transfer of the data object to each of one or more of the called communication devices.

Those skilled in the art will appreciate that the various functions of communication device 400 and server 500 may be performed using various combinations of hardware and software. Accordingly, each of the described processing blocks may in some embodiments directly correspond to one or more commercially available or custom microprocessors, microcontrollers, or digital signal processors. In other embodiments, however, two or more of the processing blocks or functional elements of device 400 or data object server 500 may be implemented on a single processor, while functions of other blocks are split between two or more processors. Likewise, memories 451 and 510 are representative of the one or more memory devices containing the software, firmware, and data used to implement functionality in accordance with one or more embodiments of the present invention. Thus, these memory devices may include, but are not limited to, the following types of devices: cache, ROM, PROM, EPROM, EEPROM, flash, SRAM, and DRAM.

Those skilled in the art should appreciate that the present invention broadly provides methods and apparatus for supporting delivery of a data object used to alert a called party to a call from a calling party. The present invention may, of course, be carried out in other specific ways than those herein set forth without departing from the scope and essential characteristics of the invention. Thus, the present invention is not limited to the features and advantages detailed in the foregoing description, nor is it limited by the accompanying drawings. Indeed, the present invention is limited only by the following claims, and their legal equivalents.

What is claimed is:

1. A method for supporting delivery of a data object used to alert a called party to a call from a calling party, the method comprising:
receiving a call setup request from a calling communication device associated with the calling party; and
initiating a call setup with one or more called communication devices associated with the called party;
wherein initiating the call setup comprises sending to the one or more called communication devices one of:
an instruction to wait for one or more caller-originated alert signals; and
an instruction to download one or more caller-originated alert signals.

2. The method of claim 1, wherein the call setup request comprises an identifier indicating one of the data object and the data object's type, and wherein initiating the call setup further comprises sending the identifier to the one or more called communication devices.

3. The method of claim 1, wherein the call setup request comprises an address where the data object is stored, and wherein initiating the call setup further comprises sending the address to the one or more called communication devices.

4. The method of claim 1, further comprising:
receiving a request for the data object from one or more of the called communication devices in response to initiating the call setup; and
transferring the data object to each of the one or more of the called communication devices, wherein the data object is used by the one or more of the called communication devices to alert the called party to the call from the calling party.

5. The method of claim 4, wherein transferring the data object to each of the one or more of the called communication devices comprises selecting the data object in accordance with information on the capabilities of the each of the one or more called communication devices received with the request for the data object.

6. The method of claim 5, wherein transferring the data object to each of the one or more of the called communication devices further comprises selecting the data object in accordance with one or more of pre-stored preferences for the called party.

7. The method of claim 4, wherein transferring the data object to each of the one or more of the called communication devices comprises sequentially transferring the data object to each of the one or more of the called communication devices.

8. The method of claim 1, further comprising sending a request to a data object server for transfer of the data object to each of one or more of the called communication devices, wherein the data object is used by the one or more of the called communication devices to alert the called party to the call from the calling party.

9. The method of claim 8, wherein the call setup request comprises an address where the data object is stored, and wherein sending the request to the data object server comprises addressing the request using the address.

10. The method of claim 8, wherein sending the request to the data object server comprises addressing the request using a default address stored in a user profile for the called party or the one or more called communication devices.

11. A communication server for supporting delivery of a data object used to alert a called party to a call from a calling party, the communication server comprising processing logic configured to:
receive a call setup request from a calling communication device associated with the calling party; and
initiate a call setup with one or more called communication devices associated with the called party;
wherein the processing logic is configured to initiate the call setup by sending to the one or more called communication devices one of:
an instruction to wait for one or more caller-originated alert signals; and
an instruction to download one or more caller-originated alert signals.

12. The communication server of claim 11, wherein the call setup request comprises an identifier indicating one of the data object and the data object's type, and wherein the processing logic is further configured to initiate the call setup by sending the identifier to the one or more called communication devices.

13. The communication server of claim 11, wherein the call setup request comprises an address where the data object is stored and wherein the processing logic is further configured to initiate the call setup by sending the address to the one or more called communication devices.

14. The communication server of claim 11, wherein the processing logic is further configured to:
receive a request for the data object from one or more of the called communication devices in response to initiating the call setup; and
transfer the data object to each of the one or more of the called communication devices, wherein the data object is used by the one or more of the called communication devices to alert the called party to the call from the calling party.

15. The communication server of claim 14, wherein the processing logic is further configured to select the data object in accordance with information on the capabilities of the each of the one or more called communication devices received with the request for the data object.

16. The communication server of claim 15, wherein the processing logic is further configured to select the data object in accordance with one or more of pre-stored preferences for the called party.

17. The communication server of claim 14, wherein the processing logic is configured to transfer the data object to each of the one or more of the called communication devices sequentially.

18. The communication server of claim 11, wherein the processing logic is further configured to send a request to a data object server for transfer of the data object to each of one or more of the called communication devices, wherein the data object is used by the one or more of the called communication devices to alert the called party to the call from the calling party.

19. The communication server of claim 18, wherein the call setup request comprises an address where the data object is stored and wherein the processing logic is configured to send the request to the data object server request using the address.

20. The communication server of claim 18, wherein the processing logic is configured to send the request to the data object server request using a default address stored in a user profile for the called party or the one or more called communication devices.
